(19) United States
(12) Patent Application Publication
(10) Pub. No.: US 2008/0115219 A1
(43) Pub. Date: May 15, 2008

(54) APPARATUS AND METHOD OF DETECTING FILE HAVING EMBEDDED MALICIOUS CODE

(75) Inventors: Yun-Ju KIM, Gyeonggi-do (KR); Youngtae YUN, Taejon (KR)

Correspondence Address: RABIN & Berdo, PC, 1101 14TH STREET, NW, SUITE 500, WASHINGTON, DC, 20005, US

(73) Assignee: Electronics and Telecommunications Research, Taejon (KR)

(21) Appl. No.: 11/780,303

(22) Filed: Jul. 19, 2007

(30) Foreign Application Priority Data
Nov. 13, 2006 (KR) 10-2006-0111853
Apr. 19, 2007 (KR) 10-2007-0038466

(51) Int. Cl. G06F 11/00

(52) U.S. Cl. 726/25

(57) ABSTRACT

An apparatus and method of detecting a file having an embedded malicious code by confirming normality/abnormality of a process that operates in a file process is disclosed. The apparatus includes an execution code detection module for detecting whether an executable file format is included in a file to be inspected through a static analysis, a support program searching module for searching for a support program according to an extension of the file to be inspected and reporting a corresponding process name and an execution path, an abnormal process detection nodule for monitoring the searched support process and judging whether a parent process of a newly created process is normal using a tree structure of the process, and an abnormal process compulsory ending module for compulsorily ending the newly created process if it is judged that the file to be inspected is the file having the embedded malicious code. Accordingly, execution of all abnormal processes can be checked.

### BACKGROUND OF THE INVENTION

1. Field of the Invention

The present invention relates to a method of detecting a file having an embedded malicious code which executes a certain executable file format using any vulnerability in processing a file format such as “doc”, “ppt”, “x1s”, “hwp”, “wmf”, and so forth, supported by a specified program, and more particularly to an apparatus and method of detecting a file having an embedded malicious code by confirming normality/abnormality of a process that operates in a file process.

2. Background of the Related Art

Recently, many attacks have been made through a technique of executing a certain code embedded in a file, using any vulnerability of programs that support specified extensions, such as doc-MS Office, ppt-MS Office PowerPoint, x1s-MS Office, Excel, hwp-Hangul, wmf-MS Windows Media Player, and so forth.

According to this technique, if a user executes a corresponding program when a file having an embedded malicious code is transferred through an email, messenger, P2P, and so forth, the malicious code is executed. This may greatly threaten general users.

As a method of detecting an attack using MS Office products group, Korean Patent Application No. 10-2005-0044241 discloses a method of detecting an Office document having an embedded malicious code. This method detects a malicious code using the vulnerability that executes the embedded malicious code using a macro function of Office documents of Microsoft products group. Currently, it is impossible to detect the embedded malicious code through domestic and foreign-made vaccine programs.

Conventional methods including the above-described method relate to techniques of coping with an attack that executes a specified malicious code using the macro function only or techniques of detecting a malicious code by a well-known patent matching method.

However, such conventional methods have the drawbacks in that the detection of an embedded malicious code is impossible in the case where the embedded malicious code is encoded and does not use the vulnerability that executes a certain code using a macro function.

### SUMMARY OF THE INVENTION

Accordingly, the present invention is directed to an apparatus and method of detecting a file having an embedded malicious code, which substantially obviates one or more problems due to limitations and disadvantages of the related art.

It is an object of the present invention to provide an apparatus and method of detecting a file having an embedded malicious code, which can cope with an attack using any vulnerability in a process in which all programs process file formats supported by themselves, in addition to a macro function, and can originally check the execution of all abnormal processes operating in a file process that does not correspond to a basic pattern matching technique.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

In order to achieve the above objects, there is provided an apparatus for detecting a file having an embedded malicious code, according to the present invention, which includes an execution code detection module for detecting whether an executable file format is included in a file to be inspected through a static analysis; a support program searching module for searching for a support program according to an extension of the file to be inspected and reporting a corresponding process name and an execution path; an abnormal process detection module for monitoring the searched support process and judging whether a parent process of a newly created process is normal using a tree structure of the process; and an abnormal process compulsory ending module for compulsorily ending the newly created process if it is judged that the file to be inspected is the file having the embedded malicious code.

In another aspect of the present invention, there is provided a method of detecting a file having an embedded malicious code, which includes (1) performing a static analysis to judge whether an executable file format exists in a file to be inspected; (2) if an MZ header and a PE header which correspond to the executable file format do not exist in the file to be inspected as a result of performing the static analysis, monitoring whether a new process is created by executing a support program of the file to be inspected; and (3) judging whether the new process for the file to be inspected is normal according to a result of monitoring.

The method of detecting a file having an embedded malicious code according to embodiments of the present invention may further include (4) if it is judged at step (3) that the new process is an abnormal process, judging that the file to be inspected is a malicious file and compulsorily ending the new process.

The step (2) may include (2-1) searching for the support program that supports the file to be inspected; (2-2) executing the file to be inspected with the support program; and (2-3) monitoring whether the new process is created through the execution of the support program.

The step (3) may include (3-1) confirming whether a parent process of the new process monitored at step (2) is a process of the support program using a tree structure of the process; (3-2) if the parent process is the process of the support program, searching whether the new process name exists in a normal process DB; and (3-3) if the new process name does not exist in the normal process DB as a result of search, judging that the new process is an abnormal process.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram illustrating the entire construction of an apparatus for detecting a file having an embedded malicious code according to an embodiment of the present invention; and

FIG. 2 is a flowchart illustrating a method of detecting a file having an embedded malicious code according to an embodiment of the present invention.

### DETAILED DESCRIPTION OF THE PREFERRED EMBODIMENT

An apparatus and method of detecting a file having an embedded malicious code according to the preferred embodiment of the present invention will now be explained in detail with reference to the accompanying drawings.

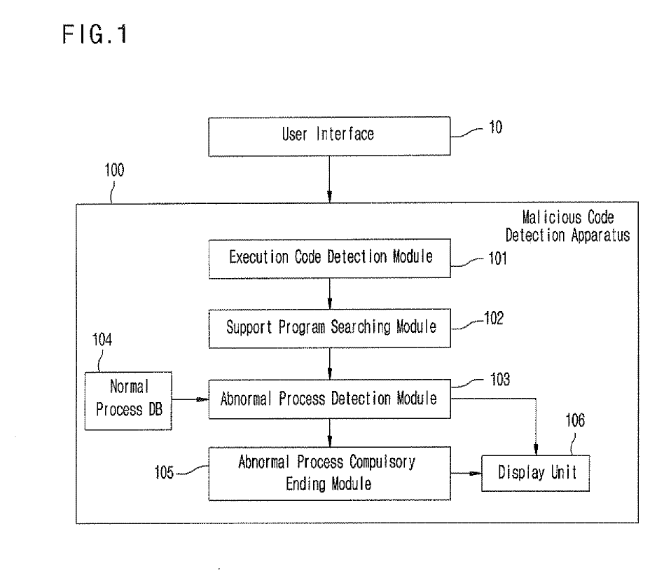

FIG. 1 is a block diagram illustrating the entire construction of an apparatus for detecting a file having an embedded malicious code according to an embodiment of the present invention.

Referring to FIG. 1, the apparatus 100 for detecting a file having an embedded malicious code according to an embodiment of the present invention includes an execution code detection module 101, a support program searching nodule 102, an abnormal process detection module 103, a normal process DB 104, an abnormal process compulsory ending module 105, and a display unit 106.

According to the present invention, the apparatus 100 for detecting a file having an embedded malicious code receives a file to be inspected from a user through a user interface 10, checks if the malicious code is included in the received file to be inspected, and outputs the result of checking.

Specifically, the execution code detection module 101 detects whether an MZ header and a PE header that correspond to an executable file format are included in the file to be inspected by performing a static analysis of the file to be inspected that is received through the user interface 10.

If the MZ header and the PE header that correspond to the executable file format are included in the file to be inspected as a result of detection, the execution code detection module 101 judges that the file to be inspected is a file having an embedded malicious code, i.e., a malicious file, while if not, it searches for a support program that can execute the file to be inspected.

More specifically, the execution code detection module 101 searches for an executable file formation with respect to the file to be inspected, and inspects DOS MZ header and PE header parts to check whether a corresponding string follows the PE format standard that suits a general PE file structure and is executable. If the two conditions are met, the execution code detection module 101 detects that the malicious code has been embedded in the corresponding file.

Here, PE, which is an abbreviation of ‘portable executable’, is a basic file format of Win32. The term ‘portable executable’ means ‘commonly usable in a Win32 platform’. All Win32 executable files (except for V×D and 16-bit DLL) use the PE file format.

On the other hand, if the malicious code is not detected from the file to be inspected, the support program searching module 102 searches for a program that supports the file formation of the file to be inspected.

Specifically, the support program searching module 102 searches for a support program that corresponds to an extension of the file to be inspected, and reports the corresponding process name and execution path. For example, if the extension of the file to be inspected is “doc”, the support program searching module 102 searches for the corresponding support program and reports the result of search, i.e., the process name and execution path of MS Office Word.

The abnormal process detection module 103 monitors support processes that execute the file to be inspected, and judges whether a parent process of the newly created process is a support program and corresponds to a normal process as well through the search of the normal process DB 104.

Here, in the normal process DB 104, processes normally created from programs have been defined and stored.

If the parent process is not searched from the normal process DB 104 as a result of search, the abnormal process detection module 103 judges that the new process is an abnormal process and thus the file to be inspected is a malicious file, while if the parent process is searched, it judges that the new process is a normal process and thus the file to be inspected is a normal file. Then, the abnormal process detection module 103 outputs the result of judgment through the display unit 106.

The abnormal process detection module 103 judges an abnormal process through a relation between a parent process and a child process since all processes in Win32 have a tree structure. Accordingly, if an abnormal process is created in the process of executing a program that supports the file format of the file to be inspected, the abnormal process detection module 103 judges that the file is the malicious file.

When the file to be inspected is judged to be the malicious file, the abnormal process compulsory ending module 105 compulsorily ends the newly created process and outputs that the file to be inspected is the malicious file through the display unit 106.

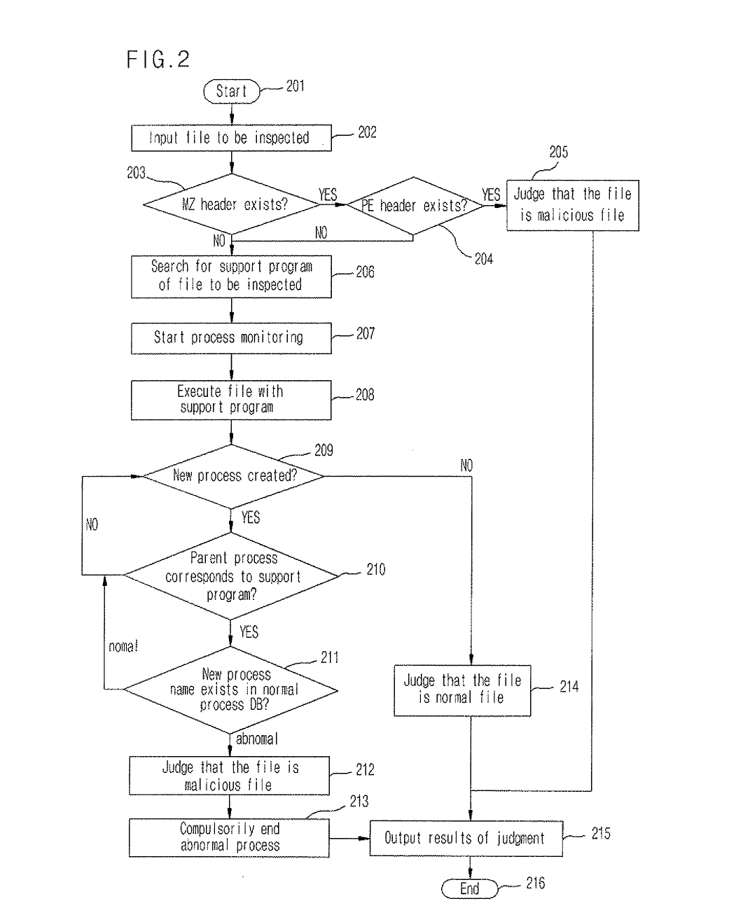

Now, a process of detecting a file having an embedded malicious code, which is performed by the apparatus 100 for detecting the file having the embedded malicious code as described above, will be described in detail with reference to FIG. 2.

FIG. 2 is a flowchart illustrating a method of detecting a file having an embedded malicious code according to an embodiment of the present invention.

When a user starts the apparatus and program (step 201) and inputs a file to be inspected through the user interface 10 (step 202), the execution code detection module 101 inspects whether an MZ header exists in the file to be inspected through a static analysis (step 203).

If the MZ header exists in the file to be inspected as a result of inspection (step 203), the execution code detection module 110 inspects whether the PE header exists in the file (step 204). If the PE header exists in the file, the execution code detection module 101 judges that the file is a file having an embedded malicious code (step 205), outputs the result (step 215), and then ends the apparatus and program (step 216),

If the MZ header does not exist in the file to be inspected as a result of inspection at step 203, the support program searching module 102 searches for a support program that supports the file to be inspected (step 206). The abnormal process detection module 103 starts monitoring of support processes (step 207), and executes the file to be inspected with the searched support program (step 208).

The abnormal process detection module 103 confirms whether a new process is created during the monitoring (step 209), and if the new process is created as a result of confirmation, it confirms whether a parent process of the created process is a process of the support program using the tree structure of the process (step 210).

If the parent process of the created process is the process of the support program as a result of confirmation at step 210, the abnormal process detection module searches whether the new created process name exists in the normal process DB 104 (step 211).

If the new created process name does not exist in the normal process DB 104 as a result of search at step 211, the abnormal process detection module judges that the file is the malicious file (step 212), and the abnormal process compulsory ending module 105 compulsorily ends the new process that is the abnormal process (step 213), outputs that the file is the malicious file (step 215), and then ends the apparatus and the program (step 216). Otherwise, the abnormal process detection module repeats the process monitoring until the support program is ended (step 209).

If the new process is not created until the support program is ended as a result of confirmation at step 209, or if the new created process is normal as a result of search at step 211, the abnormal process detection module judges that the corresponding file is a normal file, Outputs the result of judgment (step 215), and ends the apparatus and the program (step 216).

As described above, according to the apparatus and method of detecting a file having an embedded malicious code according to the present invention, unknown malicious code embedded in a file can be detected using the creation of an abnormal process according to the execution of a lower process in addition to an executable file. In addition, malicious files using the vulnerability in processing a file format supported by a specified program can be detected.

While the apparatus and method of detecting a file having an embedded malicious code according to the present invention has been described and illustrated herein with reference to the preferred embodiment thereof, it will be understood by those skilled in the art that various changes and modifications may be made to the invention without departing from the spirit and scope of the invention, which is defined in the appended claims.

1. An apparatus for detecting a file having an embedded malicious code, comprising: an execution code detection module for detecting whether an executable file format is included in a file to be inspected through a static analysis;
a support program searching module for searching for a support program according to an extension of the file to be inspected and reporting a corresponding process name and an execution path;
an abnormal process detection module for monitoring the searched support process and judging whether a parent process of a newly created process is normal using a tree structure of the process; and
an abnormal process compulsory ending module for compulsorily ending the newly created process if it is judged that the file to be inspected is the file having the embedded malicious code.

2. The apparatus of claim 1, wherein the execution code detection module detects whether an MZ header and a PE header that correspond to the executable file format exist in the file to be inspected through the static analysis.

3. The apparatus of claim 1, wherein the abnormal process detection module judges whether a parent process of the newly created process is normal, depending on whether a corresponding process name exists in a normal process DB.

4. The apparatus of claim 1, wherein if the abnormal process detection module judge that a parent process of the newly created process is an abnormal process, the abnormal process compulsory ending module judges that the file to be inspected is the file having the embedded malicious code, and compulsorily ends the newly created process.

5. A method of detecting a file having an embedded malicious code, comprising:
(1) performing a static analysis to judge whether an executable file format exists in a file to be inspected;
(2) if an MZ header and a PE header which correspond to the executable file format do not exist in the file to be inspected as a result of performing the static analysis, monitoring whether a new process is created by executing a support program of the file to be inspected; and
(3) judging whether the new process for the file to be inspected is normal according to a result of monitoring.

6. The method of claim 5, wherein the static analysis is performed to inspect whether the MZ header and the PE header which correspond to the executable file format exist in the file to be inspected.

7. The method of claim 6, wherein if the MZ header and the PE header which correspond to the executable file format exist in the file to be inspected as a result of static analysis, it is judged that the file to be inspected is the file having the embedded malicious code, a result of judgment is outputted, and then the process is ended.

8. The method of claim 5, wherein the step (2) comprises:
(2-1) searching for the support program that supports the file to be inspected;
(2-2) executing the file to be inspected with the support program; and
(2-3) monitoring whether the new process is created through the execution of the support program.

9. The method of claim 5, wherein the step (3) comprises:
(3-1) confirming whether a parent process of the new process monitored at step (2) is a process of the support program using a tree structure of the process;
(3-2) if the parent process is the process of the support program, searching whether the new process name exists in a normal process DB; and
(3-3) if the new process name does not exist in the normal process DB as a result of search, judging that the new process is an abnormal process.

10. The method of claim 9, wherein the step (3) comprises judging that the parent process of the new process is a normal process if the parent process monitored at step (2) exists in the normal process DB, outputting that the file to be inspected is a normal file, and then ending the process.

11. The method of claim 5, further comprising (4) if it is judged at step (3) that the new process is an abnormal process, judging that the file to be inspected is a malicious file, and compulsorily ending the new process.

12. The apparatus of claim 1, wherein the abnormal process detection module judges whether a parent process of the newly created process is normal, depending on whether a corresponding process name exists in a normal process DB.
